(19) United States
(12) Patent Application Publication
(10) Pub. No.: US 2026/0110286 A1
(43) Pub. Date: Apr. 23, 2026

(54) Turbine for Cross-flow Kite Power System and Method of the same

(71) Applicant: National Tsing Hua University, Hsinchu (TW)

(72) Inventors: Che-Chih Tsao, Hsinchu (TW); An-Hsuan Feng, Hsinchu (TW)

(21) Appl. No.: 19/363,843

(22) Filed: Oct. 21, 2025

Related U.S. Application Data
(60) Provisional application No. 63/709,618, filed on Oct. 21, 2024.

(51) Int. Cl. F03B 17/06; F03B 5/00

(52) U.S. Cl. CPC F03B 17/06; F03B 5/00; F05B 2240/97

(57) ABSTRACT

This invention describes the concept of a new configuration of cross-flow kite power system and its operation method. An analytical model was developed as analysis and design method for the design of the system and, especially, to design the generator turbine to match the kite in order to obtain maximal power.

### CROSS REFERENCE TO RELATED APPLICATIONS

This application claims the benefit of provisional patent application Ser. No. 63/709,618, filed on Oct. 21, 2024, by the present inventors, which is incorporated by reference in its entirety.

### BACKGROUND OF THE INVENTION

### 1. Field of the Invention

This invention is related to a power generation system that applies a kite flying across a flow, of either air or water, and carrying a generator turbine. Specifically, this invention is related to how the generator turbine should be designed to match the kite in order to obtain maximal power output.

### 2. Background

Large scale water flows in the sea, such as tidal streams or ocean currents, provide ample fluid kinetic energy that can be captured and converted into mechanical or electric power. A turbine, especially horizontal axis turbine, is usually applied for such purpose in developing approaches.

For a turbine fixed in an open flow field, which is similar to the case of a typical wind turbine standing in wind, the rules and goals of turbine or blade design for best performance are well established. By the famous Betz theory, the fluid kinetic power that can be extracted by a turbine in a flow can be expressed as

$${P}_{t} = {C}_{p} {A}_{t} \frac{ρ {V}_{0}^{3}}{2} , \qquad ( 1 )$$

where ρ is density of the fluid, V₀ is the flow velocity upstream of the turbine, the term ρV₀³/2 is the fluid kinetic power per unit cross-sectional area of the flow, Aₜ is the swept area of the turbine rotor and Cₚ is the power coefficient of the turbine. That is, only a fraction, Cₚ, of the kinetic power passing through the swept area Aₜ can be extracted. This power coefficient cannot exceed 16/27, which is called the Betz limit. Therefore, in general, a practical power generating turbine is designed to have a power coefficient Cₚ as close to this Betz limit as possible.

In another approach generally called “tidal kite”, as illustrated in FIG. 1, a glider-like kite 1 mounted with an on-board generator turbine 2, anchored to seafloor 4 with a tether 3, rides the current flow and “flies” across the current, usually along a path 5 of a circle or a FIG. 8. In general, the kite can fly at a velocity, relative to the fluid, higher than the velocity of the current flow. That is, the on-board turbine now “sees” an apparent flow velocity Vₐ faster than flow velocity V₀ and the extracted power becomes,

$${P}_{tk} = {C}_{p} {A}_{t} \frac{ρ {V}_{a}^{3}}{2} , \qquad ( 2 )$$

which means that more power can be extracted from a turbine of the same rotor size or a turbine with a smaller rotor can be used to generate the same power as a larger turbine, providing significant potential cost benefit. A typical tidal kite system is provided by Minesto AB of Frölunda, Sweden. Related descriptions of the technology can be found in minesto.com or in US Pat. App. Pub. No. US20110266805A1 “Submersible Plant” and in EP3440341B1 “Submersible plant comprising buoyant tether”.

Thus, in the case of tidal kite, or any other similar systems using a kite or a glider to gain a faster apparent flow velocity for a generator turbine, what should be the power coefficient Cₚ of the turbine that flies with the kite? Does a turbine with a power coefficient Cₚ close to the Betz limit give the best power output for the combined kite-turbine system?

### BRIEF SUMMARY OF THE INVENTION

This invention describes the concept of a new configuration of cross-flow kite power system and its operation method. An analytical model was developed as an analysis and design method for the design of the system and, especially, to design the feature parameters of the kite-turbine system in order to obtain maximal power. By these analysis and design, this invention describes a preferred kite-turbine system that uses a turbine of a power coefficient much lower than the Betz limit but can capture higher power.

The design concept for a traditional fluid kinetic power generating turbine is to make the turbine's power coefficient as close to the theoretical Betz limit as possible. But in a cross-flow kite power system, the efficiency or power capacity of the whole system should be more important than the efficiency of the turbine alone. Analysis and design using the analytical model described in this invention indicates that applying a turbine with a high “velocity transit ratio”, but a power coefficient much lower than the Betz limit, the kite can fly faster and the system can obtain more power. This invention also comprises a new spit-module configuration of kite power system and a new arrangement for mooring multiple units of kite power system in series.

### BRIEF DESCRIPTION OF THE DRAWINGS

FIG. 1 depicts the operation of a tidal kite with an integrated kite-turbine configuration with a turbine at the front of the kite in the prior art.

FIG. 2 depicts the basic configuration of the Split-Module Kite Power system according to the current invention.

FIG. 3A depicts a kite with an on-board turbine in a flight scenario where the direction of flight is perpendicular to the direction of flow velocity V₀. FIG. 3B depicts the Split-Module Kite Power system in the same flight scenario. FIG. 3C compares the apparent flow velocities seen by the two kites in velocity triangle analysis.

FIG. 4 depicts a top view of a simplified 2D view of half of the trajectory of a cross-flow kite system flying on a horizontal plane, for the analytical model of the current invention.

FIG. 5 depicts a close-up view of the Split-Module Kite Power system, also with major force vectors on it, for the analytical model of the current invention.

FIG. 6 show power coefficient Cₚ and thrust coefficient C_{Dt} of a turbine as functions of velocity transit ratio Tv under the assumption of no friction loss.

FIG. 7A shows the dimensionless apparent flow velocity in relation to the velocity transit ratio for different turbine rotor sizes, as estimated by the analytical model developed in the current invention. FIG. 7B shows the dimensionless power extracted in relation to the velocity transit ratio for different turbine rotor sizes, as estimated by the analytical model developed in the current invention.

FIG. 8A and FIG. 8B shows the same data as FIG. 7A and FIG. 7B but using dimensionless rotor size on the horizontal axes.

FIG. 9 shows power coefficient Cₚ and thrust coefficient C_{Dt}(λ_{D}) of a turbine as functions of velocity transit ratio Tv when drag over turbine blades is considered and when a design tip speed ratio λ_{D} is pre-set.

FIG. 10A depicts how the buoyancy center shifting mechanism works to adjust the roll angle of the kite according to the current invention. FIG. 10B depicts the adjustment of the pitch angle of the kite for maintaining desired angle of attack during flight by adjusting the tail plane according to the current invention.

FIG. 11 illustrates how the Split-Module Kite Power system travels cross-stream back and forth on a horizontal plane according to the current invention.

FIG. 12 illustrates an application example of the Split-Module Kite Power system acting as a stand-alone undersea instrument platform, carrying an ADCP (Acoustic Doppler Current Profiles) as a payload, according to the current invention.

FIG. 13A depicts a preferred design for mooring multiple kite systems in serial on a common tether according to the current invention. FIG. 13B shows the side view of FIG. 13A.

### DETAILED DESCRIPTION

### Split-Module Kite Power System Configuration

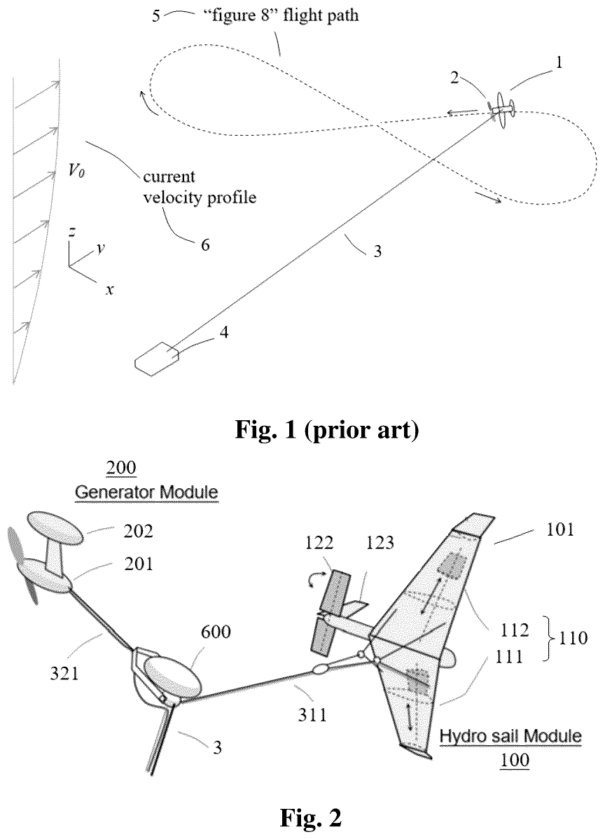

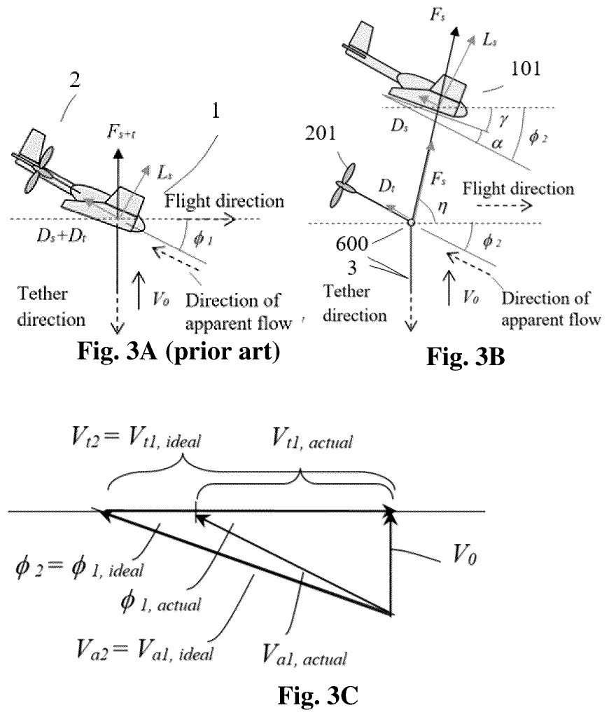

It is convenient to first describe a preferred new kite-turbine configuration in order to describe the new design method and the preferred turbine parameters. The new configuration is called Split-Module configuration. In the new configuration, as shown in FIG. 2, the turbine 201 (in the Generator Module 200) and the kite 101 (in the Kite Module 100, also called Hydro sail Module 100 when the system is operating in water) are separate and are linked respectively to a Control Pod 600, which also acts as a main buoy and a 3-line joint, by a short turbine tether 321 and a short sail (kite) tether 311. This arrangement takes the turbine away from the kite and allows a more complete and uninterrupted flow field for both the kite and the turbine. Potentially, this setup helps to increase lift on the kite and enhance power generation efficiency on the turbine, when compared to integrated kite-turbine systems such as the one depicted in FIG. 1, which has a turbine at the front end of the kite, or the example depicted in FIG. 3A, which has a turbine mounted at rear of the kite.

FIG. 3A depicts a kite 1 with an on-board turbine 2 in a flight scenario where the direction of flight is perpendicular to the direction of flow velocity V₀. FIG. 3B depicts the Split-Module Kite Power system in the same flight scenario. FIG. 3C compares the apparent flow velocities seen by the two kites in velocity triangle analysis. In an ideal case, the two kites should fly at the same velocity V_{t1, ideal}. Velocity vectors of V₀ and V_{t1, ideal} will form an ideal apparent flow velocity V_{a1, ideal}. However, no matter where the turbine 2 is placed onboard kite 1, the on-board turbine 2 inevitably affects the flow passing over kite 1. Assuming the same kite geometry and the same turbine are used, the kite with on-board turbine will have a lift lower than the ideal lift of the kite geometry alone can offer. As a result, kite 1 will fly at a velocity V_{t1, actual} slower than V_{t1, ideal}. On the other hand, in the Split-Module Kite Power system, the lift of the kite 101 is not, or much less, affected by the turbine 201. As a result, both the true velocity Vₜ₂ and the apparent velocity Vₐ₂ of the Split-Module Kite Power system will be higher than those of the kite with an on-board turbine, V_{t1,actual} and V_{a1,actual}, as depicted in FIG. 3C. The angle between the flight direction and apparent flow velocity is the direction (or angle) of apparent flow. Therefore, the Split-Module Kite Power system sees a smaller apparent flow angle of φ₂ than kite 1 does (φ_{1, actual}). Both the velocity Vₐ₂ and the angle φ₂ of the apparent flow velocity of the Split-Module Kite Power system will be close to the ideal cases when the kite and the turbine do not interfere the flow fields around each other. In addition, turbine efficiency of the Split-Module Kite Power system will also be higher because the flow entering the turbine is also much less affected by the flow field, especially wakes, around and behind the kite.

### Analytical Model

[see CSR design_d4.doc for details of the derivation]

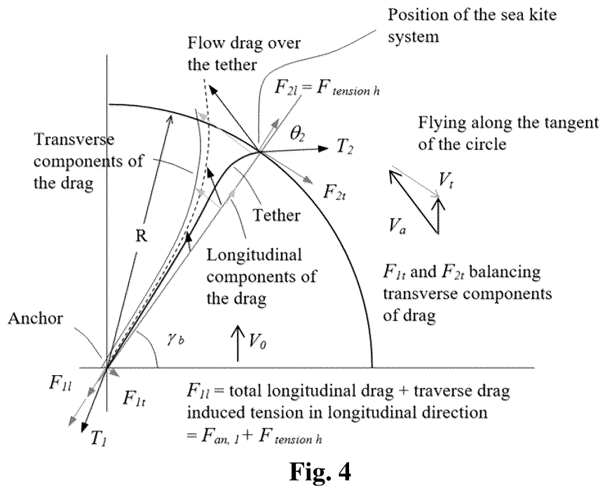

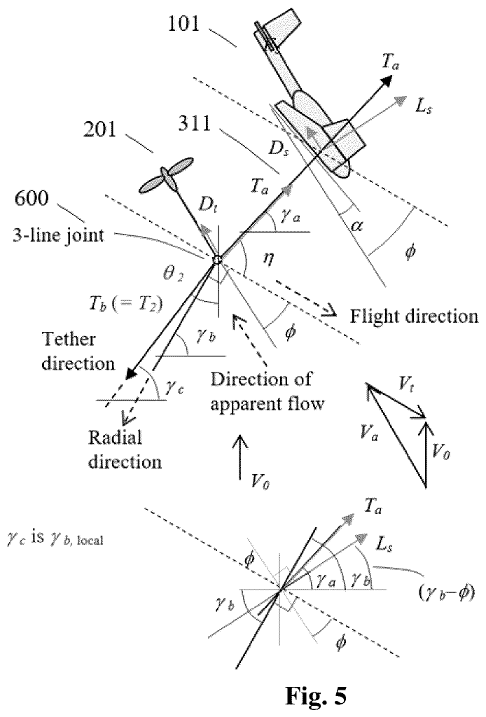

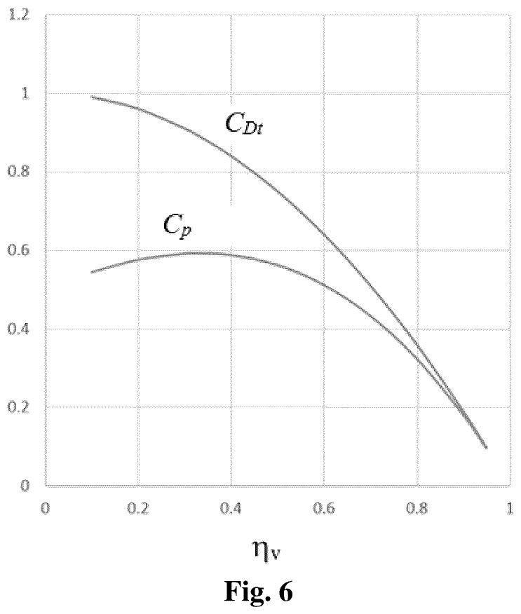

With the Split-Module configuration described above, an analytical model of the kite system can be described. FIG. 4 depicts a top view of a simplified 2D view of half of the trajectory of a kite flying on a horizontal plane, basically along a circular arc of radius R, when it is flying outward to a position corresponding to a deployment angle γ_{b}, defined as shown in the figure. This is a simplified depiction for easy analysis. Also depicted is the tether with major force vectors at its two ends as well as drags over the tether. FIG. 5 depicts a close-up view of the Split-Module Kite Power system in a general flight scenario, marked with major force vectors and major angles of interests including system deployment angle γ_{b}, sail (kite) tether angle γₐ, and apparent flow angle φ. Because of the Split-Module configuration, the lift force Lₛ and drag force Dₛ on the kite can be expressed as

$${L}_{s} = \frac{1}{2} ρ {A}_{s} {V}_{a}^{2} {C}_{L} \qquad ( 3 )$$

$${D}_{s} = \frac{1}{2} ρ {A}_{s} {V}_{a}^{2} {C}_{D} , \qquad ( 4 )$$

where Aₛ is the kite planform area and C_{L} and C_{D} are the lift and drag coefficients of the kite without being affected by the turbine. Similarly, the turbine's thrust force can be expressed as

$${D}_{t} = \frac{1}{2} ρ {A}_{t} {V}_{a}^{2} {C}_{Dt} \qquad ( 5 )$$

where C_{Dt} is the thrust coefficient without being affected by the kite.

Because the sail (kite) tether 311 connecting the kite and the turbine is short, flow drag over it is ignored. But the flow drag over the main tether connecting the anchor and the kite system (at the turbine) must be considered. For a small, differential element of the tether at a position of radius r from the anchor, the differential flow drag can be expressed in terms of the standard flow drag formula with the frontal projected area of the differential element dr as

$${dD}_{c} = \frac{1}{2} ρ ( d dr ) ( \frac{{V}_{t} ( r ) + {V}_{0} cos {v}_{b}}{{V}_{a} ( r )} ) {{V}_{a} ( r )}^{2} {C}_{Dc} , \qquad ( 6 )$$

where d is the tether diameter, C_{Dc} is the drag coefficient according to the geometry of the profile of the tether viewed in the direction of the flow, V₀ is the flow velocity, Vₜ(r) and Vₐ(r) are the true velocity and the apparent flow velocity of the element respectively, both are functions of r. The drag can be resolved into two perpendicular directions, longitudinal and transverse relative to the radial direction, which is approximately same as the extending direction of the tether, as:

$${dD}_{c . longitudinal} = {dD}_{c} \frac{{V}_{a} sin {γ}_{b}}{{V}_{a} ( r )} , \qquad ( 7 )$$

$${dD}_{c . transverse} = {dD}_{c} \frac{{V}_{t} ( r ) + {V}_{2} cos {γ}_{b}}{{V}_{a} ( r )} . \qquad ( 8 )$$

Assuming the shape of the tether extension does not alter much as the system moves, the true velocity of the tether element can be expressed as

$${V}_{t} ( r ) = {V}_{t} \frac{r}{R} \qquad ( 9 )$$

where Vₜ is the true velocity of the kite system. Inserting eqns. (9) and (6) into eqns. (7) and (8) gives

$${dD}_{c . longitudinal} = \frac{1}{2} ρ ( d dr ) {C}_{Dc} ( {V}_{t} {V}_{0} sin {γ}_{b} \frac{r}{R} + {V}_{0}^{2} sin {γ}_{b} cos {γ}_{b} ) \qquad ( 10 )$$

$${dD}_{c . transverse} = \frac{1}{2} ρ ( d dr ) {C}_{Dc} ( {V}_{t}^{2} \frac{r}{{R}^{2}} + 2 {V}_{t} {V}_{0} cos {γ}_{b} \frac{r}{R} + {V}_{0}^{2} {cos}^{2} {γ}_{b} ) . \qquad ( 11 )$$

Next, the balance of forces over the kite system is considered. When the kite system moves, a quasi-static state can be assumed because any acceleration of the system can quickly be balanced by increase of flow drag due to increase of velocity. Balance of forces on the kite gives

$${T}_{a} sin {γ}_{a} = {L}_{s} sin ( {γ}_{b} - ϕ ) + {D}_{s} cos ( {γ}_{b} - ϕ ) \qquad ( 12 )$$

$${T}_{a} cos {γ}_{a} = {L}_{s} cos ( {γ}_{b} - ϕ ) - {D}_{s} sin ( {γ}_{b} - ϕ ) . \qquad ( 13 )$$

where Tₐ is tension on the sail (kite) tether. Balance of forces at the 3-line joint gives

$${T}_{b} sin {γ}_{c} = {T}_{a} sin {γ}_{a} + {D}_{t} cos ( {γ}_{b} - ϕ ) \qquad ( 14 )$$

$${T}_{b} cos {γ}_{c} = {T}_{a} cos {γ}_{a} - {D}_{t} sin ( {γ}_{b} - ϕ ) , \qquad ( 15 )$$

Where T_{b} is tension on the main tether 3, γ_{c} is the local angle of the tether at the 3-line joint, which is different from the deployment angle γ_{b} as defined by the radial line. The force exerted by the kite system in the tangent direction, i.e., the flight direction, is F₂ₜ, as indicated in FIG. 4, which equals the tangential component of the tether tension T_{b} as

$${F}_{2 t} = {T}_{b} sin ( {γ}_{b} - {γ}_{c} ) . \qquad ( 16 )$$

Rearranging the above equations can remove γ_{c} and it can be shown that the force F₂ₜ is only a function of the apparent flow direction as viewed on the kite system φ and the hydro dynamic forces acting on the kite system:

$${F}_{2 t} = {L}_{s} sin ϕ - {D}_{s} cos ϕ - {D}_{t} cos ϕ . \qquad ( 17 )$$

The moment of this force relative to the anchoring point should be balanced by the flow drag over the tether, as

$${\int }_{0}^{R} {dD}_{c . tranzverze} = {F}_{2 t} R . \qquad ( 18 )$$

As an approximation, it is assumed that the moments due to the longitudinal components of the flow drags over the tether is comparatively small. This is because the tether is generally tight and the curvature is small. Then the balance is mainly between the transverse components of the flow drags and the force component in the direction of flight at the 3-line joint, F₂ₜ, as shown in eqn. (16). Insert eqn. (17) and eqn. (11) into eqn. (18) gives

$${\int }_{0}^{R} \frac{1}{2} ρ {dC}_{Dc} ( {V}_{t}^{2} \frac{{r}^{2}}{{R}^{2}} + 2 {V}_{t} {V}_{0} cos {γ}_{b} \frac{r}{R} + {V}_{0}^{2} {cos}^{2} {γ}_{b} ) r dr = ( {L}_{s} sin ϕ - {D}_{5} cos ϕ - {D}_{t} cos ϕ ) R , \qquad ( 19 )$$

which leads to

$$\begin{matrix}{c}_{dc} dR [ \frac{1}{2} {( \frac{sin ϕ}{tan {γ}_{b}} )}^{2} + \frac{2}{3} \frac{sin ϕ sin ( {γ}_{b} - ϕ )}{sin {γ}_{b} tan {γ}_{b}} + \frac{1}{4} {( \frac{sin ( {γ}_{b} - ϕ )}{sin {γ}_{b}} )}^{2} ] \\ = ( {C}_{L} {A}_{s} ) sin ϕ - ( {C}_{D} {A}_{s} ) cos ϕ - ( {C}_{Dt} {A}_{t} ) cos ϕ\end{matrix} . \qquad ( 20 )$$

Rearranging eqn. (20) converts it into a dimensionless form of relation among major angles of interests, system geometries, major hydrodynamic coefficients and a set of parameters related to the required tether diameter:

$$\begin{matrix}\frac{{C}_{dc}}{{C}_{L}} \frac{R}{s} \frac{{V}_{a , max}}{{V}_{c}} \sqrt{{SF}_{e} {F}_{c} {C}_{L , max} \frac{0.5 ρ {V}_{0}^{2}}{0.25 {N}_{ts} {σ}_{0} π} AR} [ \frac{1}{2} {( \frac{sin ϕ}{tan {γ}_{b}} )}^{2} + \frac{2}{3} \frac{sin ϕ sin ( {γ}_{b} - ϕ )}{sin {γ}_{b} tan {γ}_{b}} ] \\ + \frac{1}{4} {( \frac{sin ( {γ}_{b} - ϕ )}{sin {γ}_{b}} )}^{2} ] = sin ϕ - ( \frac{{C}_{D}}{{C}_{L}} + \frac{{C}_{Dt}}{{C}_{L}} \frac{{A}_{t}}{{A}_{s}} ) cos ϕ\end{matrix} . \qquad ( 21 )$$

Here, the tether cable diameter d is replaced by the set of parameters at the front of the equation, where V_{a,max} is the rated maximum apparent flow designated for the tether, Nₜₛ is the number of the cables, σ₀ is the operating strength of each cable, AR is the aspect ratio of the kite, C_{L,max} is the maximum lift coefficient of a wing profile estimated after considering and downwash effect, and F_{c} is a correction factor for adjusting the estimated maximum tension for the tether and SF_{c} is an additional safety factor. All these parameters and factors are to be assigned before an analysis using the eqn. (21).

Thus, by using eqn. (21), at a deployment angle γ_{b} a corresponding apparent flow angle φ can be calculated. Further, from the velocity triangle, i.e. the vector relationship among flow velocity V₀, kite system true velocity Vₜ and apparent velocity Vₐ, and the relations among major angles depicted in FIG. 5, the apparent flow velocity and flight velocity can be expressed as

$$\frac{{V}_{a}}{{V}_{0}} = \frac{sin {γ}_{b}}{sin ϕ} , \frac{{V}_{t}}{{V}_{0}} = \frac{sin ( {γ}_{b} - ϕ )}{sin ϕ} . \qquad ( 22 )$$

Therefore, these velocity ratios can be found once angle φ is calculated. Once these velocity ratios are known, the apparent flow velocity Vₐ can be known if current flow velocity V₀ is known. Then the power generation from the system can be calculated by using eqn. (2).

In order for comparison, the power generation from the system is also expressed as a dimensionless ratio in relation to a reference power defined as

$${P}_{ref} = {A}_{s} \frac{ρ {V}_{0}^{3}}{2} , \qquad ( 23 )$$

which is the flow kinetic power measured in a cross-sectional area equal to the planform area of the kite. Dividing eqn. (2) by eqn. (23), with eqn. (22), gives the dimensionless power generation from the kite system:

$$\frac{{P}_{tk}}{{P}_{ref}} = {C}_{p} \frac{{A}_{t}}{{A}_{s}} {( \frac{sin {γ}_{b}}{sin ϕ} )}^{3} . \qquad ( 24 )$$

To help answer the question of what should the power coefficient Cₚ of a turbine in a flying kite system be, the power coefficient Cₚ and the thrust coefficient C_{Dt} are further represented in terms of a velocity transit ratio:

$${η}_{v} = \frac{{V}_{3 a}}{{V}_{a}} , \qquad ( 25 )$$

where V₃ₐ is the apparent flow velocity downstream of the turbine, that is, away from the turbine. In other words, ηᵥ is a measure of how much the flow velocity decreases after transiting the turbine. By momentum and force analysis, and assuming there is no friction loss, it can be shown that

$${C}_{Dt} = ( 1 - {η}_{v}^{2} ) \qquad ( 26 )$$

$${C}_{p} = ( 1 / 2 ) ( 1 + {η}_{v} ) ( 1 - {η}_{v}^{2} ) \qquad ( 27 )$$

The relations are shown in the chart in FIG. 6. Detailed derivation of the relation can be found in section 2.1 in Che-Chih Tsao, Zhi-Xiang Chen, An-Hsuan Feng and Agus Baharudin, “Study of Concentrated Anchoring, Siting, System Layout and Preliminary Cost Analysis for a Large Scale Kuroshio Power Plant by the Cross-stream Active Mooring”, Renewable Energy, vol. 205, pp. 66-93, 25 Jan. 2023, which is incorporated herein by reference. Thus, by changing this velocity transit ratio, Cₚ and C_{Dt} of the turbine can be adjusted and their effects on the power generation and flight velocities can be calculated by using eqns. (21), (24) and (22). It is noted that by the Betz theory for a fixed turbine, maximum Cₚ occurs at ηᵥ=1/3, with the corresponding C_{Dt}=8/9, as can be seen from the chart.

### Example Results of Analysis:

Applying the equations of the analytical model described above, analyses were conducted under the following set conditions:

$$\begin{matrix}ρ = 1025 kg / m \hat{} 3 , \\ {σ}_{0} = 500 MPa = 500 * 10 \hat{} 6 Pa \\ dynamic pressure / main tether strength ( 0.5 ρ V 0 \hat{} 2 ) / ( Nts σ 0 ) = ( 0.5 * 1025 * 2 \hat{} 2 ) / ( 4 * 500 * 10 \hat{} 6 ) = 0.000001025 \\ {C}_{d c} = 0.1 \\ R / s = 50 \\ SFe = 1 \\ {F}_{c} = 1.2 \\ {C}_{L , max} = 1.5792 \\ {V}_{a , max} = 15 -- -- this is used in estimating diameter of main tether \\ {V}_{0} = 1 m / s -- -- this is used only in dimensional cases \\ System position {γ}_{b} = 90 ° \\ {C}_{L} = 1 \\ {C}_{D} / {C}_{L} = 0.05 or 0.1 -- -- mostly using 0.1 to be practical \\ AR = 4 or 8\end{matrix}$$

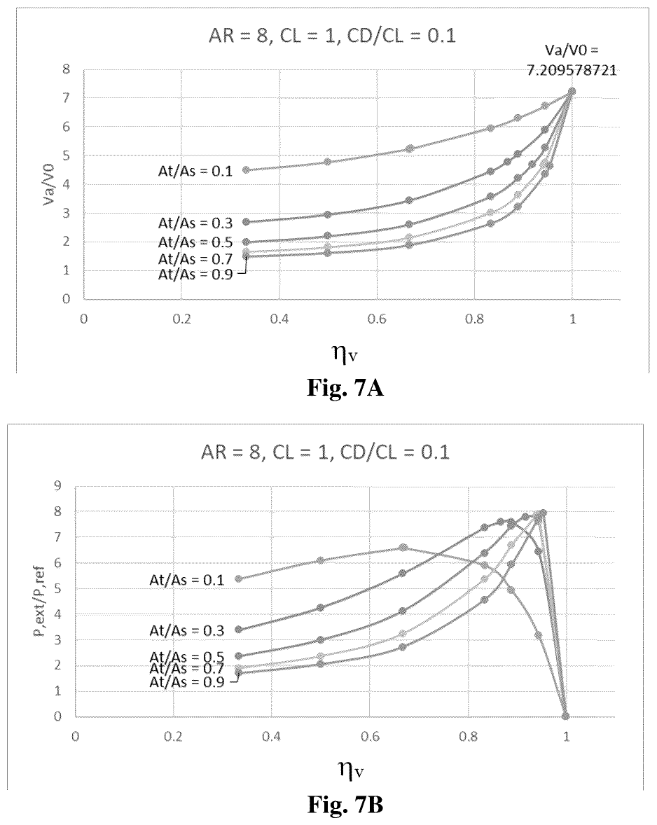

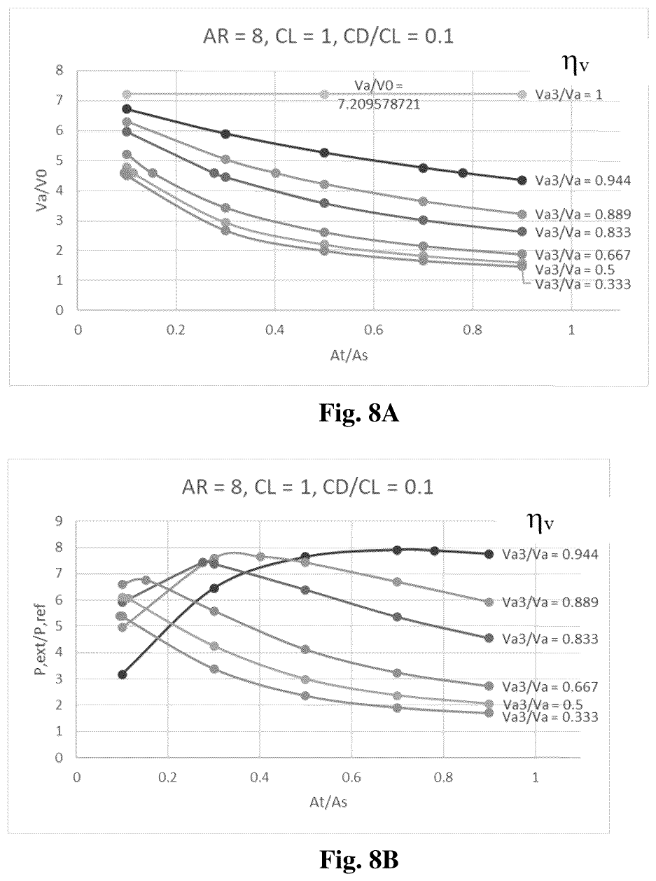

FIG. 7A shows the dimensionless apparent flow velocity in relation to the velocity transit ratio for different turbine rotor sizes. For all rotor sizes, the closer of the velocity transit ratio to 1, the faster the apparent flow velocity. FIG. 7B shows the dimensionless power generation in relation to the velocity transit ratio for different turbine rotor sizes. It can be seen that for all rotor sizes, the power extractions at the Betz optimum velocity transit ratio of 1/3 are all low. And for all rotor sizes, the maximal powers occur at much higher velocity transit ratios. And further, for a larger rotor size, maximum power occurs at a higher velocity transit ratio. These trends are generally valid for ηᵥ up to over 0.9-0.95. When ηᵥ is too close to 1, then of course very little or no power will be extracted. FIG. 8A and FIG. 8B shows that same data but use dimensionless rotor size on the horizontal axis. From FIG. 8B, it can be seen that when using a same kite, applying a turbine of high velocity transit ratio over 0.8 can generate at least 30% more power than using the Betz limit turbine at velocity transit ratio at 0.33.

Accordingly, the analysis indicates that for a turbine that “flies” with a kite, the rotor size should be made larger and the velocity transit ratio should also be made larger, within certain extend, in order to obtain highest power extraction.

In terms of more detailed turbine design, if the drag coefficient of the turbine blades is further taken into consideration, then the Betz theory for determining blade geometry can be applied to modify the expression of the thrust coefficient and to design the distributions of the chord length and twist angle of the blade. For details of the Betz theory for determining blade geometry, the following reference can be consulted: R. Gasch, J. Maurer and C. Heilmann, “Blade geometry”, Chapter 5 in Wind Power Plants: Fundamentals, Design, Construction and Operation, 2nd ed., by R. Gasch and J. Twele, Springer-Verlag Berlin Heidelberg 2012, which is incorporated herein by reference. In this case, a design tip speed ratio XD of the turbine needs to be pre-set and it becomes an additional parameter to consider. By the referred method, the following results can be derived: The apparent flow velocity corresponding to the designed tip speed ratio:

$${V}_{a} = \frac{Ω {R}_{t}}{{λ}_{D}} \qquad ( 28 )$$

where Ω is turbine rotor rotation rate and Rₜ is rotor radius.
The thrust coefficient of the turbine:

$${C}_{Dt} ( {λ}_{D} ) = ( 1 - {η}_{v}^{2} ) \{ 1 + \frac{{C}_{Dtb}}{{C}_{Ltb}} [ \frac{1 + {η}_{ν}}{{λ}_{D}} ] \} \qquad ( 29 )$$

where C_{Dtb} and C_{Ltb} are the drag and lift coefficients of the turbine blade.
The chord length of the corresponding blade:

$$c ( {r}_{tb} ) = \frac{π {{R}_{t} ( \frac{1}{{λ}_{D}} )}^{3} ( 1 + {η}_{v} ) ( 1 - {η}_{v}^{2} ) \sqrt{{( \frac{{r}_{tb}}{{R}_{t}} )}^{2} + {( \frac{1 + {η}_{v}}{2 {λ}_{D}} )}^{2}}}{\{ z [ {( \frac{1 + {η}_{v}}{2 {λ}_{D}} )}^{2} + {( \frac{{r}_{tb}}{{R}_{t}} )}^{2} ] [ {C}_{Ltb} ( \frac{1 + {η}_{v}}{2 {λ}_{D}} ) - {C}_{Dtb} ( \frac{{r}_{tb}}{{R}_{t}} ) ] \}} . \qquad ( 30 )$$

where Rₜ and r_{tb} are the rotor radius and position in the radial direction and z is the number of blades in the turbine rotor.
The twist angle of the corresponding blade:

$$β ( {r}_{tb} ) = {tan}^{- 1} [ ( \frac{1 + {η}_{v}}{2 {λ}_{D}} ) ( \frac{{R}_{t}}{{r}_{tb}} ) ] - {α}_{A} \qquad ( 31 )$$

where α_{A} is angle of attack of the blade.

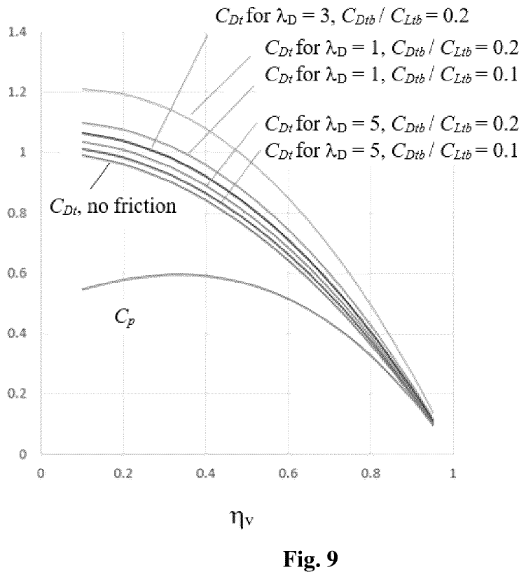

FIG. 9 shows this adjusted C_{Dt} estimated by eqn. (29) in a chart similar to that of FIG. 6, at several different sets of parameter. It can be seen that for λ_{D} larger than 3 and C_{Dtb}/C_{Ltb} smaller than 0.2, which are not difficult to achieve for common turbine rotor design, the C_{Dt} values are not too far away from the frictionless curve and the results obtained in previous paragraphs are still good estimations.

Further, although the above analysis assumes the case of the Split-Module Kite Power system, however, the method can still be applied to cases of kite systems with on-board turbine if correction factors are introduced into related hydrodynamic coefficients, such as in C_{D}, C_{L} and C_{Dt}. It is expected that the trends in the results should be similar to the results reported here.

Still further, although the design method and the results described here are mostly in the context of applications in marine currents, the Method of the same and the preferred feature parameters of turbines also applies to power generation kites operating in air, that is, in winds.

### Split-Module Kite Power System Operation

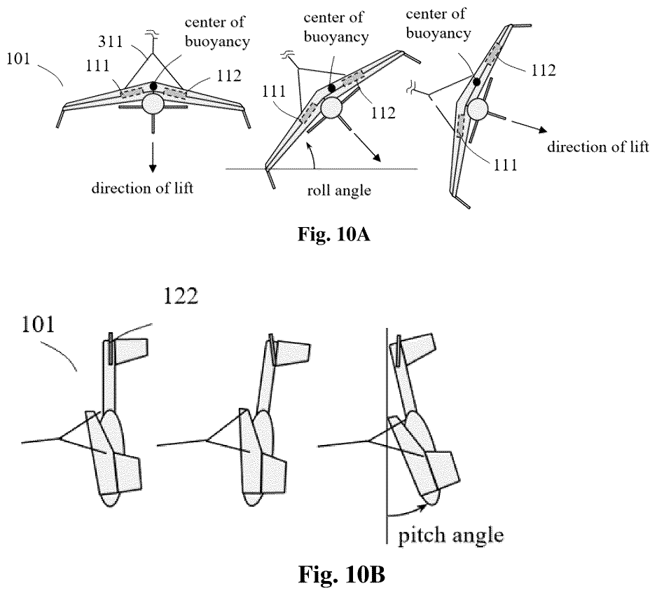

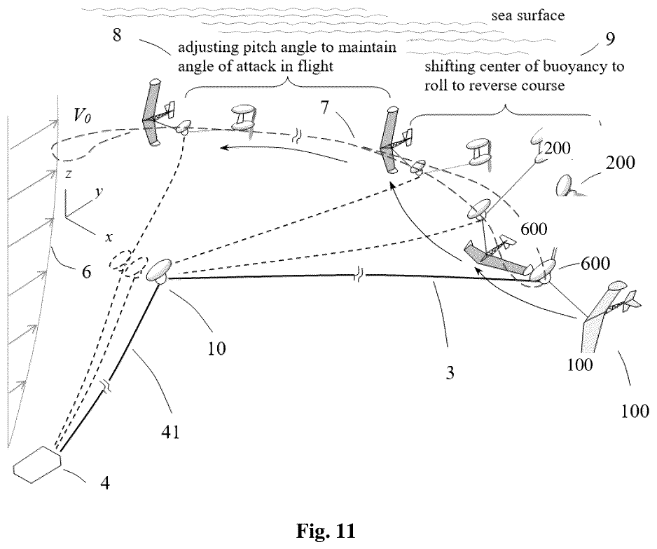

Referring to FIG. 2, the kite 101 is equipped with a buoyancy center shifting mechanism 110, which comprises two movable buoys 111 and 112 in the two wings respectively to adjust the location of buoyancy center of the kite. This mechanism enables the kite to travel cross-stream back and forth on a horizontal plane with stability and allows the turbine 201 to operate near the sea surface, where the flow is faster, and generate more power, in a basically arc-shaped horizontal flight path 7 as depicted in FIG. 11. The generator module also includes a buoy 202 on top of the turbine 201. The buoy 202 and the weight of the turbine 201 provide a counter torque to the rotational torque of the turbine and helps to keep the generator module from twisting. FIG. 10A depicts how the buoyancy center shifting mechanism works in adjusting the roll angle of the kite. The kite also has an adjustable horizontal tail plane 122 that allows the adjustment of the pitch angle of the kite for maintaining desired angle of attack during flight, as illustrated in FIG. 10B.

FIG. 11 also illustrates the mooring arrangement of for the Split-Module Kite Power system when operating in water. In general, if the water is not too deep, then a direct connection of the main tether 3 to an anchor 4 on the seafloor should work, as the case illustrated in FIG. 1. If the water is deep, compared to the desired length of the main tether 3, then the main tether forms a large angle relative to a horizontal plane where current flows on and the effectiveness of the kite will be reduced. The solution is to apply a submerged buoy 10 at a smaller depth as the anchoring point for the main tether, with the submerged buoy anchored to the deeper seafloor 4 with another section of anchor line 41, as illustrated in FIG. 11. This submerged buoy 10 has a comparatively large buoyancy so that when the pulling force on the main tether 3 generated by the flying kite pulls on the submerged buoy 10 a limited lateral displacement of the submerged buoy will create a large lateral reaction force to balance the pull. As a result, the submerged buoy does not move away too far from the original anchoring point, nor does it change depth too much. Therefore, the angle between the main tether 3 and a horizontal plane can be kept small so that the effect of the flow to the kite is not reduced.

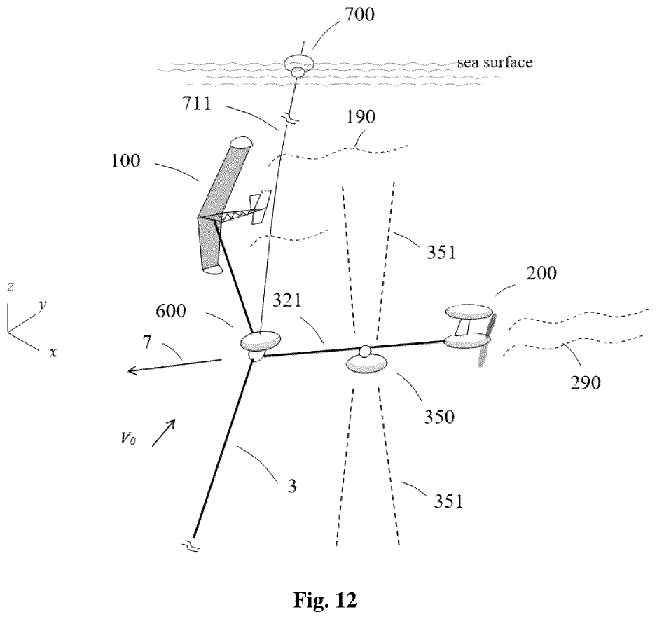

The Split-module Kite Power system can also serve as a platform for carrying payloads such as instrument or other devices because it can provide power from current flows without the need of external power connection. In fact, the system can become an undersea stand-alone and movable platform in regions of tidal streams and ocean currents. The advantage of placing the turbine generator away from the kite is that a payload can be attached to the middle of the line 321 connecting the kite and the turbine and the payload can be powered by the turbine generator and operate without being affected by wakes or disturbances created by either the turbine or the kite. For example, FIG. 12 illustrates an ADCP (Acoustic Doppler Current Profiler) as a payload in this arrangement. The flight of the kite can carry the ADCP to sweep a 2D plane to obtain current flow velocity across the whole 2D plane. By placing the ADCP 350 in the middle of line 321, the acoustic wave signals 351 will not be interfered by either the wakes 290 behind the turbine or the vortices 190 behind the kite. For command, communication and data transmission, a Floating Pod 700 can be connected to the Control Pod 600 via a mooring line with a signal cable 711 to establish a link to a remote control center through radio signals, Wi-Fi networks or satellites.

### Configuration for Serial Mooring of Power Generating Kites

In a recently proposed Cross-stream Active Mooring (CSAM) concept, referring to Tsao C. C., “Mooring System and Method for Power Generation Systems and Other Payloads in Water Flows”, U.S. Pat. No. 10,807,680 B2, 2020 Oct. 20, which is incorporated herein by reference, multiple turbines are moored on a common tether with a set of hydro sails positioned along the common tether as active stabilizer. The advantages of the CSAM concept comprise reducing the number of anchors and anchoring locations, avoiding the difficulties in anchoring on deep seafloor and the potential to track ocean current meanders. In the original CSAM concept, the hydro sail does not “fly”. Instead they take the ocean flow to stabilize and position turbines. Now, with the Split-Module Kite system, a problem is how to moor multiple kite systems to a common tether to obtain similar advantages of the CSAM concept.

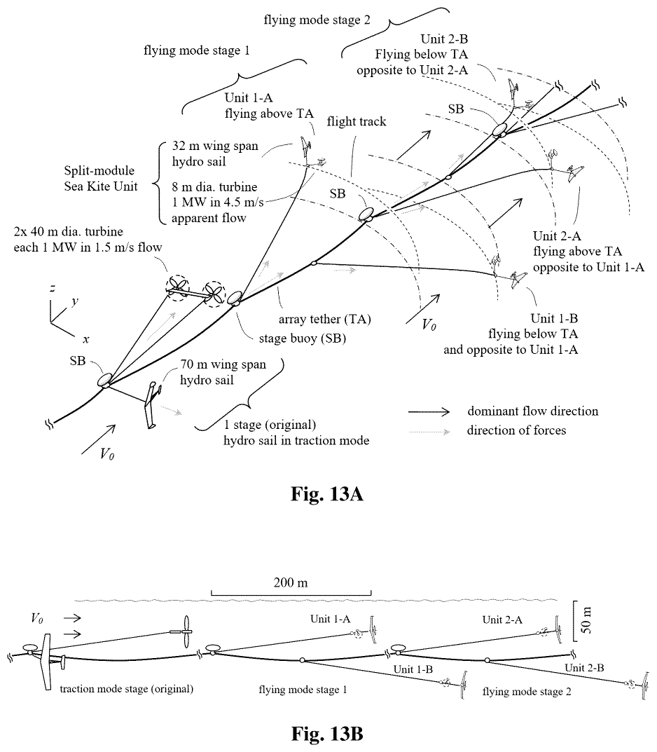

FIG. 13A depicts a preferred design for mooring multiple kite systems in serial on a common tether, showing three stages of turbines. FIG. 13B shows the side view. The first stage showing an original CSAM mooring with one large hydro sail and 2 turbines of large diameter. For convenience, the hydro sail in this stage is called operating in traction mode. The second stage (flying mode stage 1) and the third stage (flying mode stage 2) show the preferred way of mooring and operating multiple kite systems. The hydro sails and turbines are much smaller than those in stage 1 but output comparable power. Each of the second and the third stages comprises 2 kite systems. In flying mode stage 1, kite system Unit 1-A is moored to the front close to the stage buoy and flies above the common tether (array tether TA) while kite system Unit 1-B is moored in the middle of the common tether of this stage and flies below the common tether. Further, their flights are arranged with a phase difference such that they always fly in opposite direction. The same arrangement is made for the third stage too. As a result, the time-averaged resultant forces on the common tether always pull in the direction along the common tether and maintains the linear formation of the whole system.

Another problem is how to make the linear array of multiple stages to move laterally to track current meanders, as in the original CSAM concept. The method of operation is to make the two kite systems in each stage to fly paths leaning toward one side of the common tether, then the time average resultant forces will pull the linear array toward one side.

Although the above description assumes the case of the Split-Module Kite Power system, however, the mooring method and the method of operation can still be applied to cases of kite systems with on-board turbines.

What is claimed is:

1. A cross-flow kite power system for converting fluid kinetic energy in an open fluid flow comprising:
a kite riding and moving across the open fluid flow; and,
a generator turbine moving in synch with the kite, wherein the generator turbine comprising an operational feature of a velocity transit ratio over 0.7 and a ratio of swept area of rotor of the generator turbine to kite planform area between 0.2 and 0.8, the velocity transit ratio being the ratio of apparent flow velocity away from the turbine to apparent flow velocity toward the turbine.

2. A cross-flow kite power system of claim 1, further comprising:
a control pod;
an anchoring point; and,
a main tether connecting the control pod and the anchoring point;
wherein the kite and the generator turbine are separate and are connected through a kite tether and a turbine tether to the control pod respectively.

3. A cross-flow kite power system of claim 1, wherein blades of the rotor of the generator turbine comprising geometric features of
a chord length distribution based on following formula:
$$c ( {r}_{tb} ) = \frac{π {{R}_{t} ( \frac{1}{{λ}_{D}} )}^{3} ( 1 + {η}_{v} ) ( 1 - {η}_{v}^{2} ) \sqrt{{( \frac{{r}_{tb}}{{R}_{t}} )}^{2} + {( \frac{1 + {η}_{v}}{2 {λ}_{D}} )}^{2}}}{\{ z [ {( \frac{1 + {η}_{v}}{2 {λ}_{D}} )}^{2} + {( \frac{{r}_{tb}}{{R}_{t}} )}^{2} ] [ {C}_{Ltb} ( \frac{1 + {η}_{v}}{2 {λ}_{D}} ) - {C}_{Dtb} ( \frac{{r}_{tb}}{{R}_{t}} ) ] \}}$$
wherein r_{tb} is position in radial direction of the rotor, Rₜ is radius of the rotor, λ_{D} is a pre-set tip speed ratio, ηᵥ is the velocity transit ratio, C_{Dtb} and C_{Ltb} are the drag and lift coefficients of the blade, and z is the number of blades in the turbine rotor; and,
a twist angle distribution based on a following formula:
$$β ( {r}_{tb} ) = {tan}^{- 1} [ ( \frac{1 + {η}_{v}}{2 {λ}_{D}} ) ( \frac{{R}_{t}}{{r}_{tb}} ) ] - {α}_{A}$$
wherein α_{A} is angle of attack of the blade.

4. A cross-flow kite power system of claim 2 for operation in a water flow, further comprising:
a submerged buoy, the anchoring point being set on the submerged buoy to make the angle between the main tether and a horizontal plane small;
an anchor; and,
an anchor line connecting the submerged buoy and the anchor;
wherein the submerged buoy has a large buoyancy to resist lateral pulls by the kite through the main tether.

5. A cross-flow kite power system for operation in a water flow comprising:
a kite;
a generator turbine;
a control pod, the kite and the generator turbine being separate and being connected through a kite tether and a turbine tether to the control pod respectively;
an anchoring point;
a main tether connecting the control pod and the anchoring point; and,
a payload platform attached onto the turbine tether and located between the control pod and the generator turbine.

6. A cross-flow kite power system of claim 5, further comprising:
a submerged buoy, the anchoring point being set on the submerged buoy to make the angle between the main tether and a horizontal plane small;
an anchor; and,
an anchor line connecting the submerged buoy and the anchor;
wherein the submerged buoy has a large buoyancy to resist lateral pulls by the kite through the main tether.

7. A method of mooring and operating multiple cross-flow kite power systems on a common tether.
